(19) United States
(12) Patent Application Publication
(10) Pub. No.: US 2005/0014514 A1
(43) Pub. Date: Jan. 20, 2005

(54) Communications integration system for portable device

(75) Inventor: Yu-Feng Lin, Taipei City (TW)

Correspondence Address: THE LAW OFFICES OF MIKIO ISHIMARU, 1110 SUNNYVALE-SARATOGA ROAD, SUITE A1, SUNNYVALE, CA, 94087, US

(73) Assignee: Fortuna Electronic Corp., Taipei City (TW)

(21) Appl. No.: 10/861,611

(22) Filed: Jun. 3, 2004

(30) Foreign Application Priority Data
Jul. 18, 2003 (TW) 092213146

(51) Int. Cl. H04L 23/00

(52) U.S. Cl. 455/456.1

(57) ABSTRACT

A communications integration system suitable for use in a portable device is disclosed having a receiving unit for receiving Global Positioning System (GPS) signals and Radio Data System (RDS) signals, a signal integration module used to evaluate the type of signals received by the receiving unit and to process the signals, and an output unit used to output data processed by the signal integration module. With the communications integration system of the invention, information carried by GPS and RDS signals is made available in a single, integrated, portable device.

### BACKGROUND OF THE INVENTION

1. Field of the Invention

The invention relates to a communications integration system suitable for use in a portable device, and, more specifically, to a communications integration system that integrates the processing of both RDS signals and GPS signals.

2. Description of the Related Art

Cell phones and Global Positioning Systems (GPS) are portable communications products which have recently undergone intense research and development. When the user mounts a GPS signal transceiver device in a car, satellite-positioning data is transmitted to a communications base via a wireless communications platform, and then relayed to a predetermined satellite service network via a dedicated line. Linked to the service network, the user can control the general conditions of a running vehicle anywhere at anytime, such as location, speed, time, running direction, goods loading/unloading, etc.

Radio Data system (RDS), also known as the secondary carrier wave radio system, is applicable in the VHF/FM radio spectrum space at carrier frequencies ranging from 87.5 MHz-108.0 MHz for transmitting monophonic or stereophonic programs. In addition to the transmission of monophonic or stereophonic programs at a specific carrier wave frequency, information other than broadcast programs, such as warning system information, regulatory announcements, commercial services, news or traffic status can also be transmitted via a secondary waveband at a specific wave frequency. In practice, RDS is incorporated into car radios sold in European or American markets to enable the user to obtain information from the information provider.

GPS and RDS are separate information transmission systems respectively operating via the GPS network and the RDS network. However, these two networks may be operated in combination. For example, information derived from the GPS system may be transmitted via the RDS network. Even if GPS information is transmitted via the RDS network, GPS signals and RDS signals are still usually received via two individual modules. Receiving devices respectively having the GPS and RDS capability therein are rigidly-mounted devices, such as in a car audio system. These receiving devices have not been incorporated into a portable device.

Therefore, there is a need for a single module which can simultaneously process GPS and RDS signals and be incorporated into a portable device.

### SUMMARY OF THE INVENTION

It is therefore an advantage of the invention to provide a communications integration system and a communications integration process applicable to a portable device, which can integrate GPS signals and RDS signals via a signal integration module.

It is another advantage of the invention to provide a communications integration system and a communications integration process applicable to a portable device, which enable the portable device to simultaneously receive GPS signals and RDS signals.

In order to achieve the above and other advantages, a communications integration system suitable for use in a portable device includes a receiving unit, receiving signals from a Global Positioning System (GPS) and a Radio Data System (RDS); a signal integration module, evaluating the type of signals received by the receiving unit and then processing the signals; and an output unit, outputting the signals processed by the signal integration module.

According to an embodiment of the invention, a process of performing communications integration by using a communications integration system suitable for use in a portable device is further described. Signals are received via GPS and/or RDS networks by a receiving unit simultaneously or in sequence. A signal integration module integrates the GPS signals and the RDS signals received by the receiving unit. Then, an output unit outputs the signals integrated by the signal integration module.

Compared to the conventional devices, the communications integration process and the system suitable for use in the portable device according to the invention receives and integrates information from both GPS signals and RDS signals.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a schematic block diagram illustrating a communications integration system suitable for use in a portable device according to one embodiment of the invention; and

FIG. 2 is a flow chart illustrating a process of performing communications integration in the portable device according to the invention.

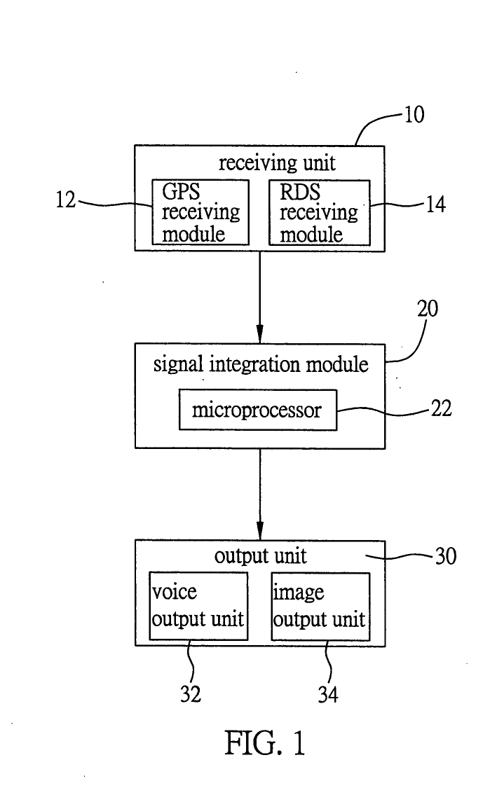

### DETAILED DESCRIPTION OF THE EMBODIMENTS

Wherever possible in the following description, like reference numerals will refer to like elements and parts unless otherwise illustrated. FIG. 1 is a block diagram illustrating a communications integration system suitable for use in a portable device according to one embodiment of the invention. The detailed structure of the communications integration system is complex, and FIG. 1 is a schematic view only for illustration purpose.

In this embodiment, the communications integration system suitable for use in a portable device includes a receiving unit 10, a signal integration module 20 and an output unit 30. The portable device is, for example, a personal digital assistant (PDA), a palm computer, a pocket computer, a cell phone, a laptop computer a tablet PC, and so on.

The receiving unit 10 at least includes a GPS signal receiving module 12 for receiving the GPS signals of the GPS communication network, and a RDS signal receiving module 14 for receiving the RDS signals of the RDS communication network. In this embodiment, the GPS signal receiving module 12 and the RDS signal receiving module 14 respectively include signal converting units (not shown) to convert received analog signals into digital signals to be processed by the communications integration system.

The signal integration module 20 integrates signals from the GPS signal receiving module 12 and/or the RDS signal receiving module 14 of the receiving unit 10. The GPS signal receiving module 12 receives GPS signals from the GPS communication network and then converts these signals into digital signals. Then, the digital signals are processed into information indicating the user's location by a microprocessor inside the signal integration module 20 to information indicating the user's location. As soon as at least three GPS signals have been received, the location of the user holding the device is determined. Likewise, when the RDS signal receiving module 14 receives information such as warning notice information, regulatory announcements, commercial or financial service information, news or real-time traffic status, etc. provided by the RDS communication network, the information is processed via the signal integration module 20 into a data format recognizable by the portable device. The data format is, for example, an image file in the jgeg format or voice file in the wav format.

It is noted that the portable device integrates GPS and RDS information received by the GPS signal receiving module 12 and the RDS signal receiving module 14 via the signal integration module 20. Therefore, according to the location of the portable device as determined using the GPS communication network, the RDS information provider indicates the user's location to the user via the RDS communication network. For instance, when the user is at 156 kms on the highway in a southern direction, the RDS information provider transmits nearby traffic or weather information to the portable device via the RDS communication network.

The output unit 30 includes at least one voice output unit 32 and an image output unit 34. The output unit 32 receives and outputs voice files generated by the signal integration module 20. The image output unit 34 receives and outputs image files generated by the signal integration module 20. Via the voice output unit 32 and the image output unit 34, weather and map information provided by the RDS signal provider is communicated by the portable device in voice and image formats.

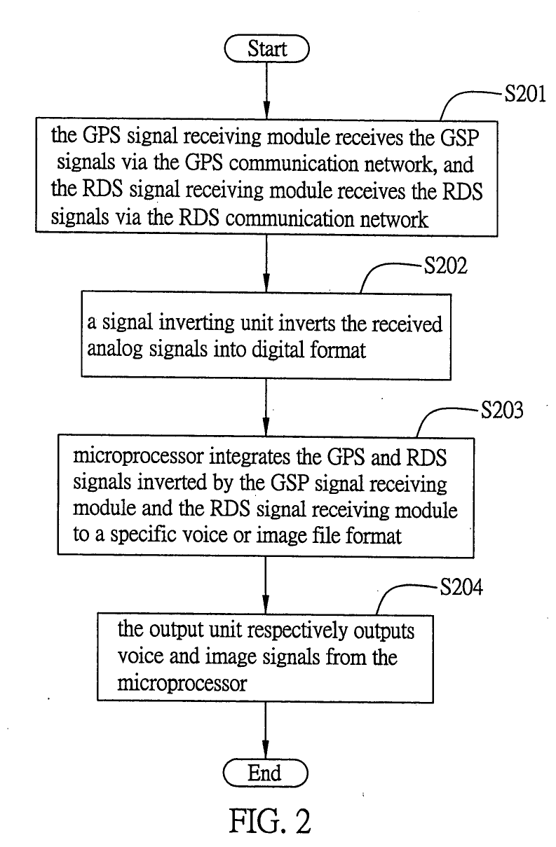

Referring to FIG. 2, a process of performing the communications integration in the portable device according to the invention includes the following the steps. At Step S201, the GPS signal receiving module 12 of the receiving unit 10 receives the GSP signals via the GPS communication network, and the RDS signal receiving module 14 receives the RDS signals via the RDS communication network. Then, go to Step S202.

At Step S202, a signal converting unit converts analog signals, respectively received by the GPS signal receiving module 12 and the RDS signal receiving module 14, into a digital format. Then, go to Step S203.

At Step S203, the microprocessor 22 of the signal integration module 20 integrates GPS and RDS signals converted by the GSP signal receiving module 12 and the RDS signal receiving module 14 to a specific voice or image file format. Then, go to Step S204.

At Step S204, the voice output unit 32 and the image output unit 34 of the output unit 30 respectively output the voice and image data from the microprocessor 22. As described above, the communications integration device suitable for use in a portable device according to the invention simultaneously receives and integrates GSP and RDS signals.

It should be apparent to those skilled in the art that the above description is only illustrative of specific embodiments and examples of the invention. The invention should therefore cover various modifications and variations made to the herein-described structure and operation of the invention, provided they fall within the scope of the invention as defined in the following appended claims.

1. A communications integration system suitable for use in a portable device, integrating and displaying information provided by different information communication networks, the communications integration system comprising:
a receiving unit, receiving signals from a Global Positioning System (GPS) and a Radio Data System (RDS);
a signal integration module, evaluating signals received by the receiving unit and processing the received signals; and
an output unit, outputting the signals processed by the signal integration module.

2. The communications integration system of claim 1, wherein the receiving unit includes a GPS signal receiving module for receiving GPS signals, and a RDS signal receiving module for receiving RDS signals.

3. The communications integration system of claim 2, wherein the GPS signal receiving module and the RDS signal receiving module respectively include a signal converting unit for converting analog signals into digital signals.

4. The communications integration system of claim 1, wherein the signal integration module includes a microprocessor that integrates and processes the GPS signals and RDS signals received and converted respectively by the GPS signal receiving module and the RDS signal receiving module.

5. The communications integration system of claim 1, wherein the output unit includes a voice output unit for outputting voice data from the signal integration module, and an image output unit for outputting images from the signal integration module.

6. The communications integration system of claim 1, wherein GPS and RDS signals are respectively transmitted via the GPS signal communication network and the RDS signal communication network.

7. A process of performing communications integration in a portable device, used to integrate and display information provided by different information communication networks, the process comprising:
receiving GPS signals and RDS signals by a receiving unit, wherein the GPS signals and the RDS signals are in analog format;
converting the analog GPS signals and the analog RDS signals into a digital format by a signal integration module;
processing and integrating the digital GPS signals and the digital RDS signals to generate a specific voice or image file format by a signal integration module; and
outputting the voice or image signals from the signal integration module to output devices.

8. The process of claim 7, wherein the receiving unit includes a GPS signal receiving module for receiving GPS signals, and a RDS signal receiving module for receiving RDS signals.

9. The process of claim 7, wherein the GPS signal receiving module and the RDS signal receiving module include signal converting units to convert analog signals into digital signals.

10. The process of claim 7, wherein the signal integration module includes a microprocessor that processes and integrates GPS signals and RDS signals respectively received and converted by the GPS signal receiving module and the RDS signal receiving module.

11. The process of claim 7, wherein the output unit includes a voice output unit used to output voice data from the signal integration module, and an image output unit used to output image data from the signal integration unit.

12. The process of claim 7, wherein GPS signals and RDS signals are respectively transmitted via a GPS communication network and a RDS communication network.
